(19) United States
(12) Patent Application Publication
(10) Pub. No.: US 2022/0287008 A1
(43) Pub. Date: Sep. 8, 2022

(54) COMMUNICATION APPARATUSES AND COMMUNICATION METHODS FOR UTILIZATION OF RELEASED RESOURCE

(71) Applicant: Panasonic Intellectual Property Corporation of America, Torrance, CA (US)

(72) Inventors: Yang KANG, Singapore (SG); Hidetoshi SUZUKI, Kanagawa (JP); Tien Ming Benjamin KOH, Singapore (SG); Lei HUANG, Singapore (SG); Xuan Tuong TRAN, Singapore (SG)

(21) Appl. No.: 17/634,937

(22) PCT Filed: Jun. 18, 2020
(86) PCT No.: PCT/SG2020/050340

§ 371 Date: Feb. 11, 2022

(30) Foreign Application Priority Data
Aug. 16, 2019 (SG) 10201907584R

(51) Int. Cl. H04W 72/02; H04W 28/26; H04W 76/30

(52) U.S. Cl. CPC H04W 72/02; H04W 28/26; H04W 76/30; H04W 80/02

(57) ABSTRACT

The present disclosure provides communication apparatuses and communication methods for utilization of released resource. The communication apparatuses include a communication apparatus comprising: a receiver which, in operation, receives release information relating to a reserved resource from another communication apparatus, the reserved resource being reserved for a transmission from the another communication apparatus; and circuitry which, in operation, selects a resource from a plurality of resource candidates when the communication apparatus is to do a subsequent transmission, wherein the plurality of resource candidates includes the reserved resource.

### TECHNICAL FIELD

The following disclosure relates to communication apparatuses and communication methods for New Radio (NR) communications, and more particularly to communication apparatuses and communication methods for utilization of released resource.

### BACKGROUND

V2X communication allows vehicles to interact with public roads and other road users, and is thus considered a critical factor in making autonomous vehicles a reality.

To accelerate this process, 5G NR based V2X communications (interchangeably referred to as NR V2X communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through sidelink (SL) with other nearby vehicles, infrastructure nodes and/or pedestrians. The status information includes information on position, speed, heading, etc.

In such V2X communications, there are at least two SL resource allocation modes being discussed by the 3GPP. In resource allocation Mode 1, SL resource(s) to be used by a UE for SL transmissions are scheduled by a base station (BS). In resource allocation Mode 2, the UE determines, i.e. the BS does not schedule, SL transmission resources within the SL resources configured by the BS/network or pre-configured SL resources. The 3GPP study on resource allocation also considers sensing and resource selection procedures for a Mode 2(a), in the context of a semi-persistent scheme where resource(s) are selected for multiple transmissions of different transmission blocks (TBs) and a dynamic scheme where resource(s) are selected for each TB transmission.

In the 3GPP RAN WG1 #96b meeting in Xi'an, the following items were considered:
NR V2X supports an initial transmission of a TB without reservation, based on sensing and resource selection procedure.
NR V2X supports reservation of a sidelink resource for an initial transmission of a TB at least by a sidelink control information (SCI) associated with a different TB, based on sensing and resource selection procedure. This functionality can be enabled/disabled by (pre-) configuration.
For further study (FFS): Standalone Physical Sidelink Control Channel (PSCCH) transmissions for resource reservations are supported in NR V2X.

In the 3GPP RAN WG1 #97 meeting in Reno, the following items were considered:
NR V2X Mode-2 supports resource reservation for feedback-based Physical Sidelink Shared Channel (PSSCH) retransmissions by signaling associated with a prior transmission of a same TB.
   FFS: impact on subsequent sensing and resource selection procedures.
   At least from the transmitter perspective of above-mentioned TB, usage of Hybrid Automatic Repeat Request (HARQ) feedback for release of unused resource(s) is supported.

However, there has been no discussion on communication apparatuses and methods for utilization of released resource.

There is thus a need for communication apparatuses and methods that provide feasible technical solutions for utilization of released resource. Furthermore, other desirable features and characteristics will become apparent from the subsequent detailed description and the appended claims, taken in conjunction with the accompanying drawings and this background of the disclosure.

### SUMMARY

Non-limiting and exemplary embodiment facilitates providing communication apparatuses and methods for utilization of released resource.

According to a first embodiment of the present disclosure, there is provided a communication apparatus comprising: a receiver which, in operation, receives release information relating to a reserved resource from another communication apparatus, the reserved resource being reserved for a transmission from the another communication apparatus; and circuitry which, in operation, selects a resource from a plurality of resource candidates when the communication apparatus is to do a subsequent transmission, wherein the plurality of resource candidates includes the reserved resource.

According to a second embodiment of the present disclosure, there is provided a communication apparatus comprising: circuitry which, in operation, determines release information relating to a reserved resource, the reserved resource being reserved for a transmission from the communication apparatus; and a transmitter which, in operation, transmits the release information to another communication apparatus.

According to a third embodiment of the present disclosure, there is provided a communication method comprising: receiving release information relating to a reserved resource, the reserved resource being reserved for a transmission from a communication apparatus; and selecting a resource from a plurality of resource candidates when a subsequent transmission is to be done, wherein the plurality of resource candidates includes the reserved resource.

According to a fourth embodiment of the present disclosure, there is provided a communication method comprising: determining release information relating to a reserved resource, the reserved resource being reserved for a transmission; and transmitting the release information to a communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary architecture for a 3GPP NR system.

FIG. 2 is a schematic drawing which shows functional split between NG-RAN and 5GC.

FIG. 3 is a sequence diagram for RRC connection setup/reconfiguration procedures.

FIG. 4 is a schematic drawing showing usage scenarios of Enhanced mobile broadband (eMBB), Massive Machine Type Communications (mMTC) and Ultra Reliable and Low Latency Communications (URLLC).

FIG. 5 is a block diagram showing an exemplary 5G system architecture for a non-roaming scenario.

FIG. 6 depicts a schematic diagram 600 illustrating how a resource may be reserved for a future transmission in V2X communications.

FIG. 7 depicts a schematic diagram 700 illustrating how a released resource may be utilised by way of an Operation A according to various embodiments.

FIG. 8 depicts a schematic diagram 800 illustrating how a released resource may be utilised by way of an Operation B according to various embodiments.

FIG. 9 shows a flow diagram 900 illustrating how a physical (PHY) layer performs sensing in Operation A and B according to various embodiments.

FIG. 10 shows a flow diagram 1000 illustrating how a PHY layer performs step 904 of flow diagram 000 in Operation A according to various embodiments.

FIG. 11 shows a flow diagram 1100 illustrating how a medium access control (MAC) layer performs release judgement and selection in Operation A according to various embodiments.

FIG. 12 shows a flow diagram 1200 illustrating how a PHY layer performs step 904 of flow diagram 1000 in Operation B according to various embodiments.

FIG. 13 shows a flow diagram 1300 illustrating how a MAC layer performs selection in Operation B and Operation C according to various embodiments.

FIG. 14 shows a flow diagram 1400 illustrating how a MAC layer performs prioritisation of a released resource according to various embodiments.

FIG. 15 depicts a schematic diagram 1500 illustrating PHY layer configuration for Operation A, B and C according to various embodiments.

FIG. 16 shows a flow diagram 1600 illustrating a communication method according to various embodiments.

FIG. 17 shows a flow diagram 1700 illustrating a communication method according to various embodiments.

FIG. 18 shows a schematic example of communication apparatus in accordance with various embodiments. The communication apparatus may be implemented as an UE or a gNB/base station and configured for utilising release resources in accordance with various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

5G NR system architecture and protocol stacks

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

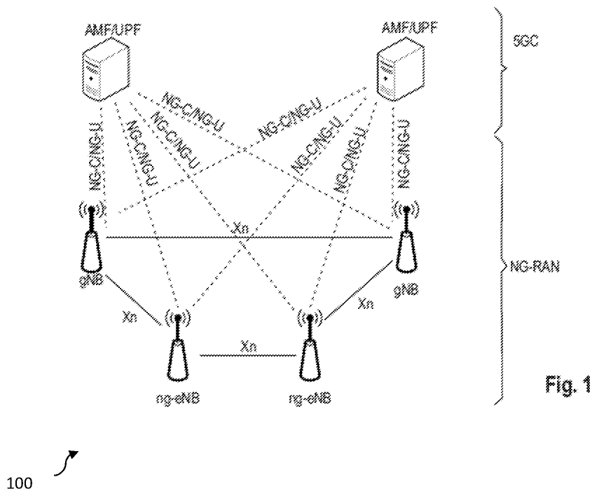

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

5G NR functional split between NG-RAN and 5GC

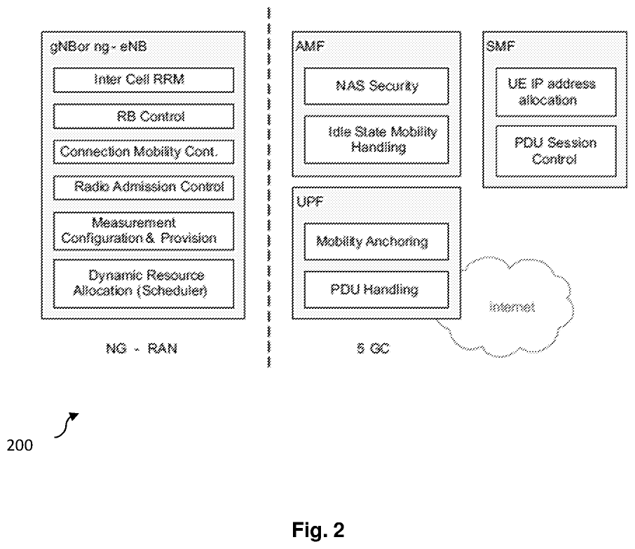

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signalling termination;
—NAS signalling security;
Access Stratum, AS, Security control;
Inter Core Network, CN, node signalling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.
   Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

RRC Connection Setup and Reconfiguration Procedures

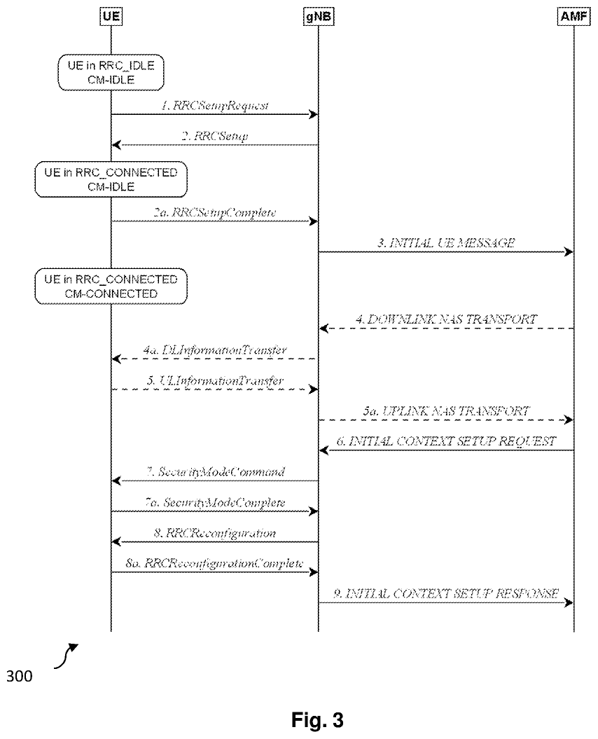

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signalling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

Usage Scenarios of IMT for 2020 and Beyond

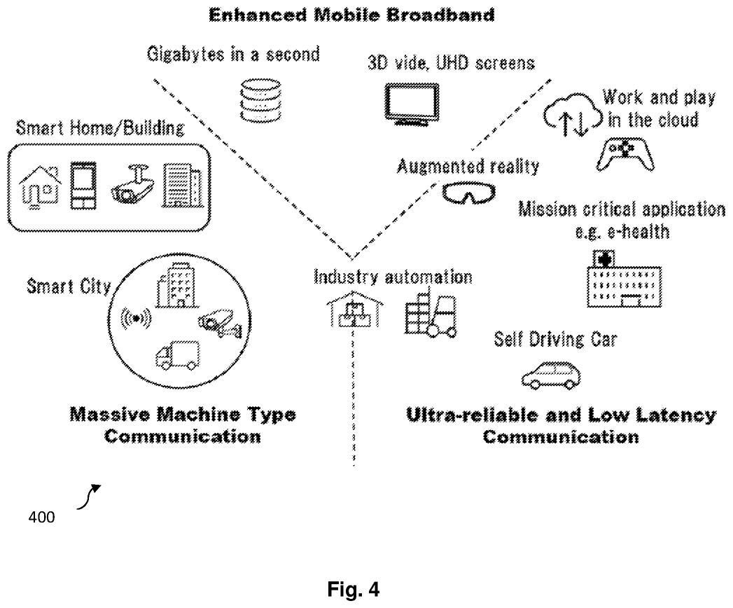

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

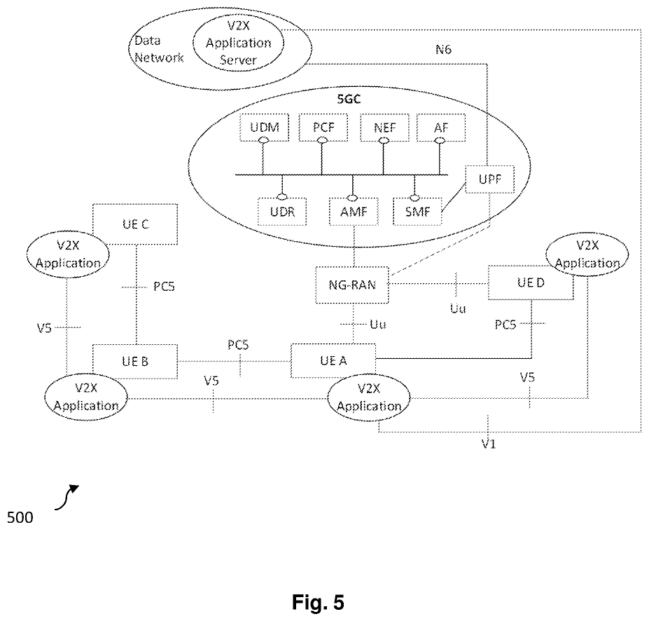

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

As mentioned above, usage of HARQ feedback for release of unused resource(s) is supported at least from a transmitting UE's perspective of a concerned TB. However, no additional signaling is defined for the purpose of release of unused resources by the transmitting UE. Further, the behavior of the receiver UE(s) of this TB and other UEs are FFS.

PHY layer sensing and reporting of resources in LTE V2X are defined in the TS36.213 section 14.1.1.6 as per the following steps:
1) A candidate single-subframe resource for PSSCH transmission R_{x,y} is defined as a set of L_{subCH} contiguous sub-channels with sub-channel x+j in subframe t_{y}^{SL} where j=0, . . . , L_{subCH}−1. The UE shall assume that any set of L_{subCH} contiguous sub-channels included in the corresponding PSSCH resource pool (described in 14.1.5) within the time interval [n+T₁, n+T₂] corresponds to one candidate single-subframe resource, where selections of T₁ and T₂ are up to UE implementations under T₁≤4 and T₂ₘᵢₙ(prio_{TX})≤T₂≤100, if T₂ₘᵢₙ(prio_{TX}) is provided by higher layers for prio_{TX}, otherwise 20≤T₂≤100. UE selection of T₂ shall fulfil the latency requirement. The total number of the candidate single-subframe resources is denoted by Mₜₒₜₐₗ.
2) The UE shall monitor subframes t_{n′-10×p}_{ₛₜₑₚ}^{SL}, t_{n′-10×p}_{ₛₜₑₚ}₊₁^{SL}, . . . , t_{n′-1}^{SL}, except for those in which its transmissions occur, where t_{n′}^{SL}=n if subframe n belongs to the set (t₀^{SL}, t₁^{SL}, . . . , t_{T}_{ₘₐₓ}^{SL}), otherwise subframe t_{n′}^{SL} is the first subframe after subframe n belonging to the set (t₀^{SL}, t₁^{SL}, . . . , t_{T}_{ₘₐₓ}^{SL}). The UE shall perform the behaviour in the following steps based on PSCCH decoded and S-RSSI measured in these subframes.
3) The parameter Th_{a,b} is set to the value indicated by the i-th SL-ThresPSSCH-RSRP field in SL-ThresPSSCH-RSRP-List where i=a*8+b+1.
4) The set S_{A} is initialized to the union of all the candidate single-subframe resources. The set S_{B} is initialized to an empty set.
5) The UE shall exclude any candidate single-subframe resource R_{x,y} from the set S_{A} if it meets all the following conditions:
   the UE has not monitored subframe t_{z}^{SL} in Step 2.
   there is an integer j which meets y+j×P′_{rsvp_TX}=z+Pₛₜₑₚ×k×q where j=0, 1, . . . , Cᵣₑₛₑₗ−1, P′_{rsvp_TX}=Pₛₜₑₚ×P_{rsvp_TX}/100, k is any value allowed by the higher layer parameter restrictResourceReservationPeriod and q=1, 2, . . . , Q. Here, Q=1/k if k<1 and m′−z≤Pₛₜₑₚ×k, where t_{n′}^{SL}=n if subframe n belongs to the set t₀^{SL}, t₁^{SL}, . . . , otherwise subframe t_{n′}^{SL} is the first subframe belonging to the set t₀^{SL}, t₁^{SL}, . . . , t_{T}_{ₘₐₓ}^{SL} after subframe n; and Q=1 otherwise.
6) The UE shall exclude any candidate single-subframe resource R_{x,y} from the set S_{A} if it meets all the following conditions:
   the UE receives an SCI format 1 in subframe tₘ^{SL}, and “Resource reservation” field and “Priority” field in the received SCI format 1 indicate the values P_{rsvp_RX} and prio_{RX}, respectively according to Subclause 14.2.1.
   PSSCH-RSRP measurement according to the received SCI format 1 is higher than Thₚᵣᵢₒ_{_{TX}}_{,prio}_{_{RX}}.
   the SCI format received in subframe tₘ^{SL} or the same SCI format 1 which is assumed to be received in subframe(s) t_{m+q×P}_{ₛₜₑₚ}_{×P}_{_{revp_RX}}^{SL} determines according to 14.1.1.4C the set of resource blocks and subframes which overlaps with R_{x,y+j×P′}_{_{rsvp_TX}} for q=1, 2, . . . , Q and j=0, 1, . . . , Cᵣₑₛₑₗ−1. Here,

$$Q = \frac{1}{{P}_{rsvp\_RX}}$$

if P_{rsvp_RX}<1 and n′−m≤Pₛₜₑₚ×P_{rsvp_RX}, where t_{n′}^{SL}=n if subframe n belongs to the set (t₀^{SL}, t₁^{SL}, . . . , T_{T}_{ₘₐₓ}^{SL}), otherwise subframe t_{n′}^{SL}, is the first subframe after subframe n belonging to the set (t₀^{SL}, t₁^{SL}, . . . , t_{T}_{ₘₐₓ}^{SL}); otherwise Q=1.
7) If the number of candidate single-subframe resources remaining in the set S_{A} is smaller than 0.2·Mₜₒₜₐₗ, then Step 4 is repeated with Th_{a,b} increased by 3 dB.
8) For a candidate single-subframe resource R_{x,y} remaining in the set S_{A}, the metric E_{x,y} is defined as the linear average of S-RSSI measured in sub-channels x+k for k=0, . . . , L_{subCH}−1 in the monitored subframes in Step 2 that can be expressed by t_{y-P}_{ₛₜₑₚ}_{*j}^{SL} for a non-negative integer j if P_{rsvp_TX}≥100, and t_{y-P′}_{_{rsvp_TX}}_{*j}^{SL} for a non-negative integer j otherwise.
9) The UE moves the candidate single-subframe resource R_{x,y} with the smallest metric E_{x,y} from the set S_{A} to S_{B}. This step is repeated until the number of candidate single-subframe resources in the set S_{B} becomes greater than or equal to 0.2·Mₜₒₜₐₗ,
10) When the UE is configured by upper layers to transmit using resource pools on multiple carriers, it shall exclude a candidate single-subframe resource R_{x,y} from S_{B} if the UE does not support transmission in the candidate single-subframe resource in the carrier under the assumption that transmissions take place in other carrier(s) using the already selected resources due to its limitation in the number of simultaneous transmission carriers, its limitation in the supported carrier combinations, or interruption for RF retuning time [10].
   The UE shall then report set s, to higher layers.

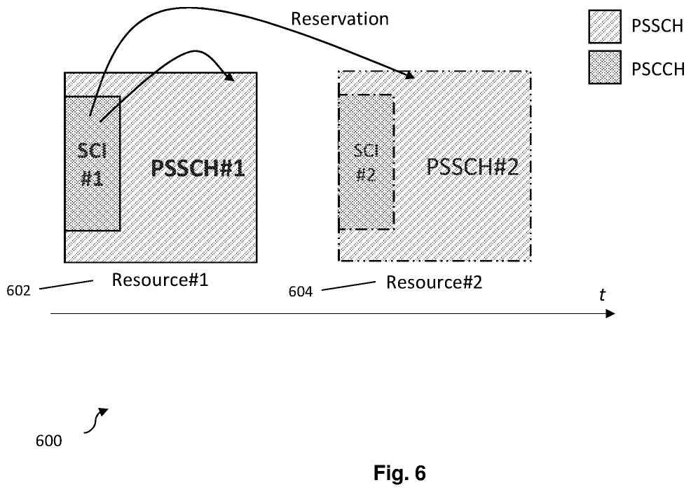

FIG. 6 depicts a schematic diagram 600 illustrating how a resource may be reserved for a future transmission in V2X communications. For example, a transmitting UE (Tx UE) may perform a SL transmission of a TB using a resource#1 602 to receiving UE(s) (Rx UE(s)).

The Tx UE and Rx UE(s) may include, for example, communication modules integrated or installed in vehicles subscribed to communication services of one or more telecommunications/Public Land Mobile Network (PLMN) operators. The Tx UE and Rx UE(s) may be subscribed to a telecommunication/PLMN operator operator and communicates with a base station of the telecommunication operator. The base station may be a next generation NodeB (gNB). It can be appreciated by those skilled in the art that the base station 602 can also be a ng-eNB, and may be connected via the NG interface to a 5G core network.

The SL transmission of the TB may be via a Physical Sidelink Shared Channel (PSSCH) and its corresponding control information SCI may be transmitted via a Physical Sidelink Control Channel (PSCCH). Accordingly, as shown in FIG. 1, a SCI#1 in resource#1 602 indicates a current transmission (SCI#1+PSSCH#1) in resource#1 602, and also reserves a resource#2 604 for possible future transmission (SCI#2+PSSCH#2) for the same target receiver(s) i.e. the Rx UE(s).

Under certain circumstances, the Tx UE may cancel its future transmission of SCI#2+PSSCH#2, and the reserved resource#2 604 will then be treated as released. For example, when PSSCH#2 is a possible HARQ retransmission of PSSCH#1, the resource#2 604 can be released if PSSCH#1 is received successfully.

Thus far, 3GPP has only discussed the signalling for releasing a reserved resource for HARQ retransmission. However, it is still not clear how to utilize the released resource (i.e., the behavior of the Rx UE(s), the Tx UE and other UEs of the current transmission).

Therefore, the present invention proposes an improved communication procedure such that the released resource may be utilized by the Rx UE(s), Tx UE and other UEs.

In the following paragraphs, certain exemplifying embodiments are explained with reference to a V2X communications mechanism that advantageously allows a released resource to be utilised by Rx UE(s), Tx UE and other UEs of a current transmission.

For a sidelink resource reserved by a UE for a future transmission (i.e. after a current transmission has occurred), when the reserved resource is released by the UE, the release information/signalling is made known to certain UEs (e.g., Tx UE, or Tx UE & Rx UEs). The released resource may then be included during resource selection by the UE(s) which are aware of the release information, for possible subsequent transmission from the UE(s). As the reservation is known to all UEs which receives/decodes the control information in the current transmission, these UE will exclude the reserved resource during their sensing procedures. Advantageously, there will be lower chance of over-the-air collisions on the released resource.

Referring back to FIG. 6, a Tx UE may perform a sidelink transmission of TB#1 in resource 602. The SCI#1 in resource#1 602 indicates the current transmission (SCI#1+PSSCH#1) in resource#1 602, and also reserves resource#2 604, which may be used as a future transmission such as, for example, a future HARQ retransmission, for the same target receiver as PSSCH#1. The transmission of TB#1 in resource#1 602 can be a unicast to another UE, or groupcast to a group of UEs, or a broadcast. For all UEs (not only the target receiver of PSSCH#1) to receive SCI#1 where the reference signal received power (RSRP) of SCI#1 is higher than Th_{a,b}, the future transmission in resource#2 is reserved. The Tx UE is aware that the resource#2 604 can be released when the transmission of TB#1 in resource#1 602 is successfully received by the receiver UEs, for example by receiving a release information through a Physical Sidelink Feedback Channel (PSFCH) from the receiver UEs. The release information may be any explicit or implicit signal for informing that the reserved resource can be released, such as an acknowledgement feedback (for example, HARQ-ACK or non-NACK) from the receiver UEs to the Tx UE. The Tx UE may also determine and transmit release information to other UEs to inform that the resource#2 604 is released, so that these UEs can include the resource#2 604 in their resource selection for their own transmissions. In various embodiments, the release information may be generated from an associated base station or gNB to the Tx UE and Rx UE(s), for example in the case of Mode-1 transmissions.

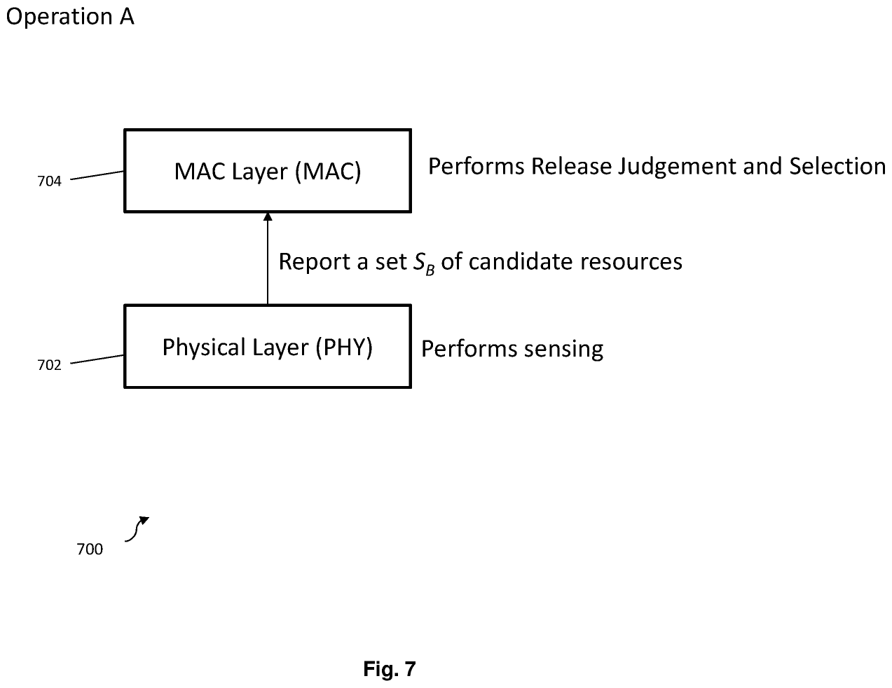

FIG. 7 depicts a schematic diagram 700 illustrating how a released resource may be utilised by way of an Operation A according to various embodiments, after a UE is aware of release information relating to a reserved resource, the reserved resource being one which may be reserved for a transmission. For example, the Tx UE as described in FIG. 6 may reuse the released resource#2 604 for a subsequent transmission of another TB, for example a TB#2. Under Operation A, the PHY layer 602 of Tx UE performs sensing procedures for candidate resources from an initial set S_{A} and then reports a set of candidate resources S_{B} to the MAC layer 604 of the Tx UE. The initial set of S_{A} contains all Mₜₒₜₐₗ candidate resources for subsequent transmission of TB#2. The PHY layer 602 may perform, during the sensing procedures, a step of resource exclusion such that the reserved resource#2 604 will not be excluded from the initial set S_{A} if the reserved resource#2 604 is within S_{A}. Conversely, the reserved resource#2 604 will be excluded from the initial set S_{A} if the reserved resource#2 604 is not within S_{A}. The set S_{B} that is reported to the MAC layer 704 contains ≥20%*Mₜₒₜₐₗ candidate resources with the lowest RSRP from the remaining set S_{A} after the resource exclusion step.

Thereafter, the MAC layer 704 performs release judgement and resource selection. Release judgement is performed on reserved candidate resources, wherein the MAC layer 704 judges whether or not a reserved candidate resource is released based on release information of the reserved candidate resource. The release information may be determined or generated by the Tx UE (i.e. for a candidate resource that is reserved for a future transmission from the TX UE, such as resource#2 604), or received from the Rx UE(s) or an associated base station. For example, if S_{B} contains resource#2 604, and the resource#2 104 is judged as released by MAC layer:

The contiguous candidate resource containing resource#2 604 (if there is sufficient size and latency) may be prioritized by the MAC layer 704 during the resource selection for subsequent transmission of TB#2

The resource#2 604 may be partially used, solely used, or used conjugately with other contiguous resources

Otherwise, the MAC layer 704 may perform a random selection of a resource from S_{B} for the transmission of TB#2.

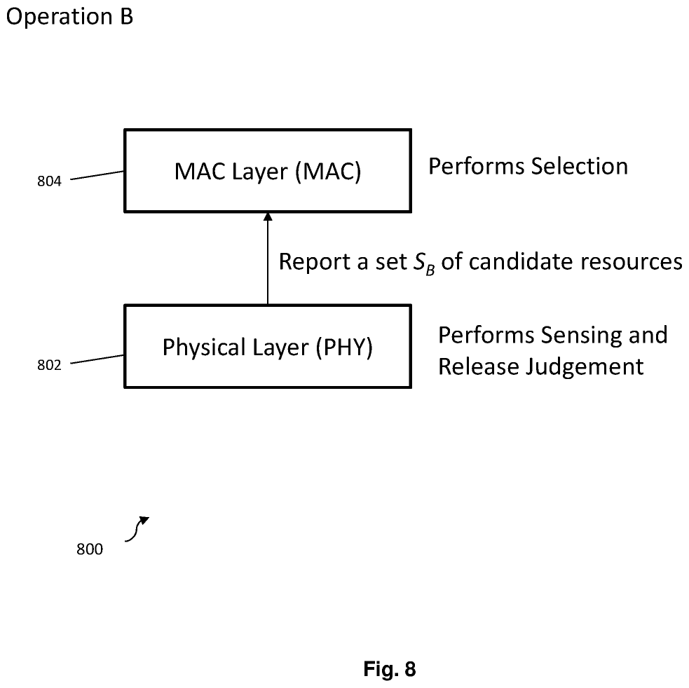

FIG. 8 depicts a schematic diagram 800 illustrating how a released resource may be utilised by way of an Operation B according to various embodiments. For example, the Tx UE as described in FIG. 6 may reuse the released resource#2 604 for a subsequent transmission of another TB, for example a TB#2. Under Operation B, the PHY layer 802 of Tx UE performs sensing procedures and release judgement for candidate resources from an initial set S_{A} and then reports a set of candidate resources S_{B} to the MAC layer 804 of the Tx UE. The initial set of S_{A} contains all Mₜₒₜₐₗ candidate resources for subsequent transmission of TB#2. The PHY layer 802 may perform, during the sensing procedures, a step of resource exclusion such that the reserved resource#2 604 will not be excluded from the initial set S_{A} if the reserved resource#2 604 is within S_{A} and if the reserved resource#2 604 is judged as released by the PHY layer 802. Conversely, the reserved resource#2 604 will be excluded from the initial set S_{A} even if the reserved resource#2 604 is within S_{A}, but the reserved resource#2 604 is judged as non-released by the PHY layer 802. Release judgement is performed on reserved candidate resources, wherein the PHY layer 802 judges a reserved candidate resource as released based on release information of the reserved candidate resource. The release information may be determined by the Tx UE (i.e. for a candidate resource that is reserved for a future transmission from the TX UE, such as resource#2 604), or received from the Rx UE(s) or an associated base station. The set S_{B} that is reported to the MAC layer 304 contains ≥20%*Mₜₒₜₐₗ candidate resources with the lowest RSRP from the remaining set S_{A} after the resource exclusion step.

Thereafter, the MAC layer 804 performs resource selection. For example, If S_{B} contains resource#2 604:

The contiguous candidate resource containing resource#2 604 (if there is sufficient size and latency) may be prioritized by MAC layer 804 during the resource selection for subsequent transmission of TB#2

The resource#2 604 may be partially used, solely used, or used conjugately with other contiguous resources

Otherwise, the MAC layer 804 may perform a random selection of a resource from S_{B} for the transmission of TB#2.

Further, a released resource may be utilised by way of an Operation C according to various embodiments, after a UE is aware of release information relating to a reserved resource. For example, the Tx UE as described in FIG. 1 may reuse the released resource#2 604 for a subsequent transmission of another TB, for example a TB#2. Under Operation C, the set of candidate resources S_{B} may be provided to the MAC layer of the Tx UE by pre-configuration, RRC or MAC. Thereafter, the MAC layer performs resource selection. For example, If S_{B} contains resource#2 604:

The contiguous candidate resource containing resource#2 604 (if there is sufficient size and latency) may be prioritized by MAC layer during the resource selection for subsequent transmission of TB#2

The resource#2 604 may be partially used, solely used, or used conjugately with other contiguous resources

Otherwise, the MAC layer may perform a random selection of a resource from S_{B} for the transmission of TB#2.

FIG. 94 shows a flow diagram 900 illustrating how a PHY layer, such as the PHY layer 702 and 802, performs sensing in Operation A and B respectively according to various embodiments. At step 902, the PHY layer senses a set S_{A} with all Mₜₒₜₐₗ candidate resources. At step 904, the PHY layer performs an iteration of resource exclusion such that candidate resources are excluded from set S_{A} if certain conditions are met. The conditions for exclusion differ for Operation A and Operation B, since the PHY layer performs release judgement in Operation B but does not do so in Operation A. At step 906, it is determined whether the number of candidate resources remaining in S_{A} after the resource exclusion step 904 is <0.2 Mₜₒₜₐₗ If it is determined that the number of candidate resources remaining in S_{A} after the resource exclusion step 904 is <0.2 Mₜₒₜₐₗ, the process proceeds to step 914 where the Th_{a,b} is increased by 3 dB, and then proceeds back to step 904 for a repeated procedure of the resource exclusion process, until it is determined at step 906 that the set S_{A} contains ≥20%*Mₜₒₜₐₗ candidate resources.

Thereafter, the process proceeds to a sorting step 908 where candidate resources with lowest RSRP are moved from S_{A} to S_{B}. In various embodiments, for step 908 under Operation B, the resource#2 604 may be given more weightage to be included in the set S_{B}, when the resource#2 604 is excluded from S_{A}, and satisfy the amount of lowest RSPR of 20% of Mₜₒₜₐₗ. In various embodiments, for step 908 under Operation A or B, the resource#2 604 may be given more weightage to be included in the set S_{B}, when the resource#2 604 is not excluded from S_{A}, but not satisfy the amount of lowest RSPR of 20% of Mₜₒₜₐₗ.

At step 910, it is determined whether the number of candidate resources in set S_{B}<0.2 Mₜₒₜₐₗ. If it is determined that the number of candidate resources in set S_{B} is <0.2 Mₜₒₜₐₗ, the process repeats sorting step 908 until the number of candidate resources in set S_{B} is ≥0.2 Mₜₒₜₐₗ. At step 412, the set S_{B} is reported to the higher layers, for example the MAC layer 704 or MAC layer 804.

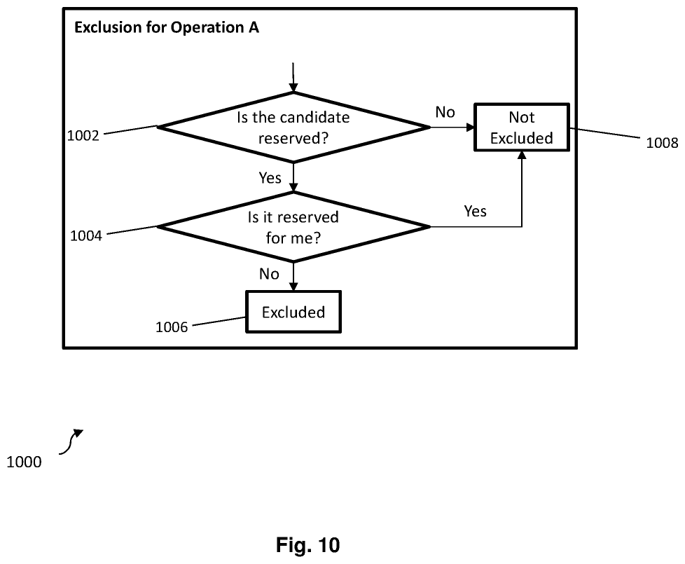

FIG. 10 shows a flow diagram 1000 illustrating how a PHY layer, such as the PHY layer 702, performs step 904 of flow diagram 900 in Operation A according to various embodiments. At step 1002, the PHY layer 702 determines whether a candidate resource is reserved. If it is determined that the candidate resource is not reserved, the process proceeds to step 1008 wherein the candidate resource is not excluded from set S_{A}. If it is determined that the candidate resource is reserved, the process proceeds to step 1004 to determine whether the candidate resource is reserved for the concerned UE, which in this case is the Tx UE. If it is determined that the candidate resource is reserved for the Tx UE, the process proceeds to step 1008 wherein the candidate resource is not excluded from set S_{A}. Otherwise, the process proceeds to step 1006 where the candidate resource is excluded. Advantageously, step 1008 ensures a lower chance of over-the-air collisions on the candidate resource.

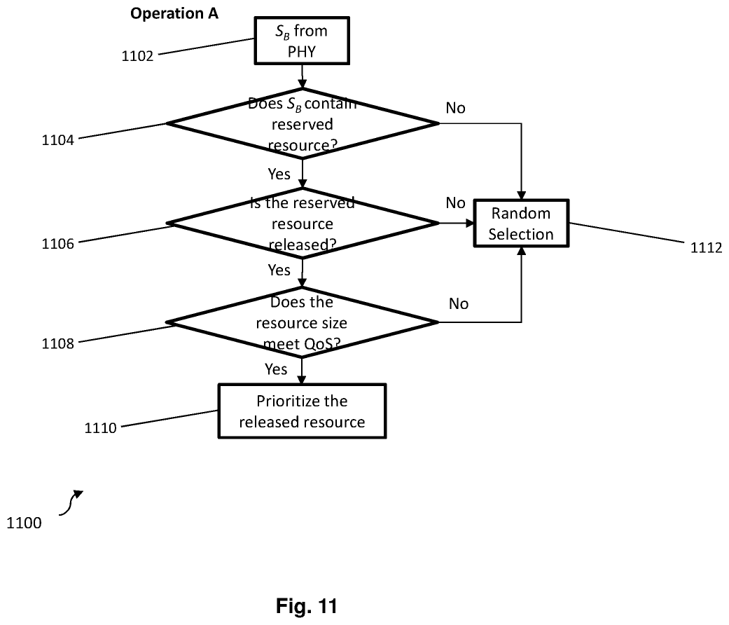

FIG. 11 shows a flow diagram 1100 illustrating how a MAC layer, such as the MAC layer 704, performs release judgement and selection in Operation A according to various embodiments. At step 1102, a set S_{B} is reported to the MAC layer 704. At step 1104, it is determined whether the set S_{B} contain a reserved resource, for example the reserved resource#2 604. If it is determined that the set S_{B} does not contain a reserved resource, the process proceeds to step 1112 wherein the MAC layer 704 performs a random selection of resources from the set S_{B} for transmission of TB#2. Otherwise, the process proceeds to release judgement step 1106, where it is judged whether the reserved resource is released. Release judgement is performed on reserved candidate resources, wherein the MAC layer 704 judges whether or not a reserved candidate resource is released based on release information of the reserved candidate resource. The release information may be determined or generated by the Tx UE (i.e. for a candidate resource that is reserved for a future transmission from the TX UE, such as resource#2 604), or received from the Rx UE(s) or an associated base station. If the candidate resource is not judged as released, the process proceeds to step 1112 wherein the MAC layer 704 performs a random selection of resources from the set S_{B} for transmission of TB#2. If the candidate resource is judged as released, the process proceeds to step 1108 where it is determined whether the candidate resource size meets Quality of Service (QoS) requirements. If it is determined that the candidate resource size does not meet QoS requirements, the process proceeds to step 1112 wherein the MAC layer 704 performs a random selection of resources from the set S_{B} for transmission of TB#2. Otherwise, the process proceeds to step 1110 wherein the MAC layer 704 prioritises the released resource over the other candidate resources when selecting a resource from the set S_{B} for transmission of the TB#2. Advantageously, the Tx UE can reuse the released resource#2 604 for a future transmission.

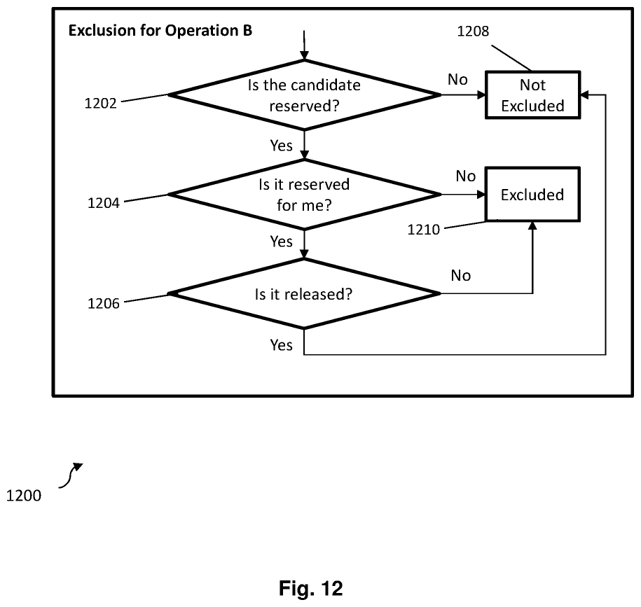

FIG. 12 shows a flow diagram 1200 illustrating how a PHY layer, such as the PHY layer 802, performs step 904 of flow diagram 900 in Operation B according to various embodiments. At step 1202, the PHY layer 802 determines whether a candidate resource is reserved. If it is determined that the candidate resource is not reserved, the process proceeds to step 1208 wherein the candidate resource is not excluded from set S_{A}. If it is determined that the candidate resource is reserved, the process proceeds to step 1204 to determine whether the candidate resource is reserved for the concerned UE, which in this case is the Tx UE. If it is determined that the candidate resource is not reserved for the Tx UE, the process proceeds to step 1210 wherein the candidate resource is excluded from set S_{A}. Otherwise, the process proceeds to release judgement step 1206, where it is judged whether the reserved candidate resource is released. Release judgement is performed on reserved candidate resources, wherein the PHY layer 802 judges whether or not a reserved candidate resource is released based on release information of the reserved candidate resource. The release information may be determined or generated by the Tx UE (i.e. for a candidate resource that is reserved for a future transmission from the TX UE, such as resource#2 604), or received from the Rx UE(s) or an associated base station. If the candidate resource is judged as released, the process proceeds to step 1208 wherein the candidate resource is not excluded from set S_{A}. Otherwise, the process proceeds to step 1210 wherein the candidate resource is excluded from set S_{A}. Advantageously, step 1204 ensures a lower chance of over-the-air collisions on the candidate resource.

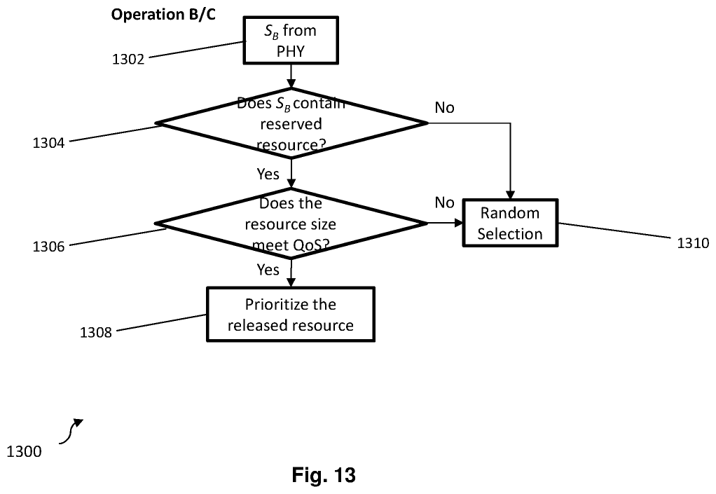

FIG. 13 shows a flow diagram 800 illustrating how a MAC layer, for example the MAC layer 804, performs resource selection in Operation B and Operation C according to various embodiments. At step 1302, a set S_{B} is reported to the MAC layer 304. At step 1304, it is determined whether the set S_{B} contain a reserved resource, for example the reserved resource#2 604. If it is determined that the set S_{B} does not contain a reserved resource, the process proceeds to step 1310 wherein the MAC layer 804 performs a random selection of resources from the set S_{B} for transmission of TB#2. Otherwise, the process proceeds to step 1306 where it is determined whether the candidate resource size meets QoS requirements. If it is determined that the candidate resource size does not meet QoS requirements, the process proceeds to step 810 wherein the MAC layer 804 performs a random selection of resources from the set S_{B} for transmission of TB#2. Otherwise, the process proceeds to step 1308 wherein the MAC layer 804 prioritises the reserved resource#2 604 over the other candidate resources when selecting a resource from the set S_{B} for transmission of the TB#2. Advantageously, the Tx UE can reuse the released resource#2 604 for a future transmission.

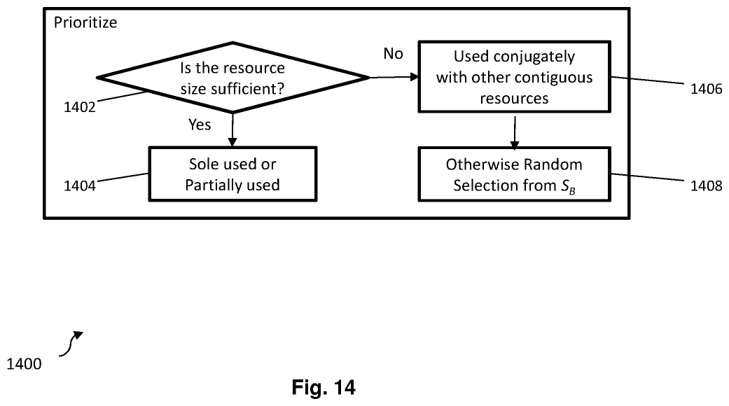

FIG. 14 shows a flow diagram 1400 illustrating how a MAC layer, for example the MAC layer 704 or 804, performs prioritisation of a released resource for Operation A, B and C according to various embodiments. The prioritisation is performed in step 1110 of flow diagram 600 and step 1308 in flow diagram 800. At step 1402, it is determined whether the resource size of reserved resource#2 604 is sufficient for the TB#2 transmission. If it is determined that the size is not sufficient, the process proceeds to step 1406 wherein the MAC layer 704 or 804 uses the reserved resource#2 104 conjugately with other contiguous resources for transmission of the TB#2. The MAC layer 704 or 804 may perform, at step 1408, a random selection from set S_{B} for the other contiguous resources. On the other hand, if it is determined that the size is sufficient, the process proceeds to step 1404 wherein the reserved resource#2 604 is solely used or partially used for the transmission of the TB#2. Advantageously, the released resource#2 604 is prioritised for reuse for the transmission of TB#2.

It will be appreciated that for the resource selection performed by the MAC layer, the released resource#2 604 may also be treated with equal probability as other candidate resources, especially when large number of UEs are aware of the release information for released resource#2 604.

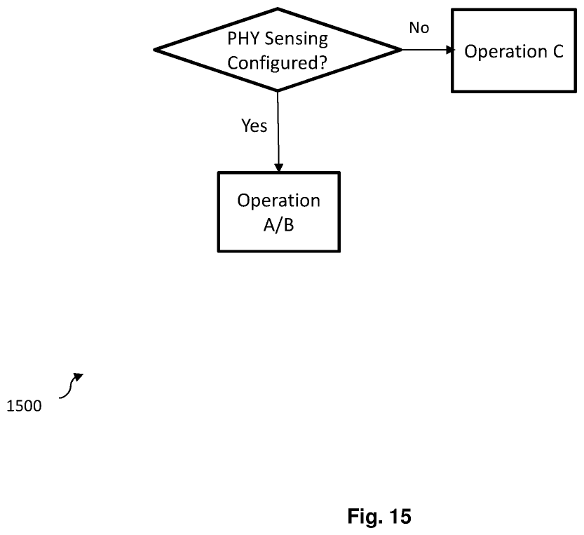

FIG. 15 depicts a schematic diagram 1500 illustrating PHY layer configuration for Operation A, B and C according to various embodiments. In Operation A and B, the PHY layer (i.e. PHY layer 702 and 802) is configured to perform sensing of candidate resources and report the resulting set S_{B} to the MAC layer (i.e. the MAC layer 704 and 804). In Operation C, however, the PHY layer is not configured to assist in resource sensing.

It will be appreciated that Operation A, B and C can also be applied to the Rx UE(s) or other UE(s) for their own future transmissions when the Rx UE(s) or other UE(s) are aware that resource#2 604 is released, for example when release information of the resource#2 604 is transmitted from the Tx UE to the Rx UE(s) or other UE(s). This applies whether the current transmission (i.e. the transmission of TB#1) is a unicast, groupcast or broadcast to the Rx UE(s). In the case of groupcast, it may be preferable that the number of Rx UEs is small, otherwise there can be more chance of collision in among the Rx UE(s). Further, the above mentioned operations can also apply to Mode-1 transmissions if the gNB grant resources for both initial transmission (i.e. resource#1) and HARQ retransmission (i.e. resource#2) of the TB sent by the Tx UE. In various embodiments where a released resource is not within the transmission resource pool of the Rx UE(s) or other UEs, no additional behaviour may be defined for the Rx UE(s) and other UEs, and only the Tx UE is able to use the released resource.

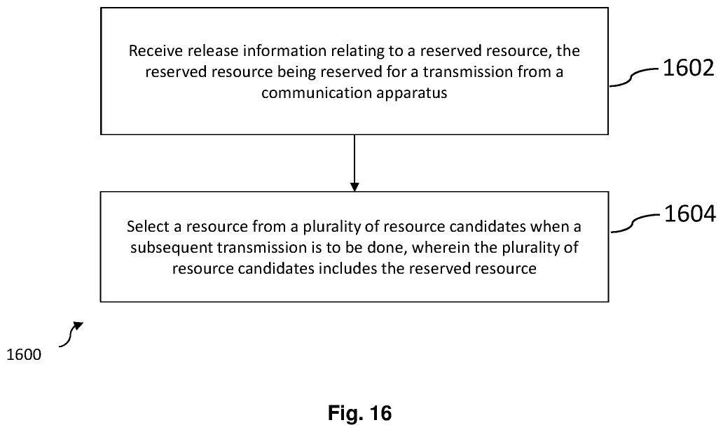

FIG. 16 shows a flow diagram 1600 illustrating a communication method according to various embodiments. In step 1602, release information relating to a reserved resource is received, the reserved resource being reserved for a transmission from a communication apparatus. In step 1604, a resource from a plurality of resource candidates is selected when a subsequent transmission is to be done, wherein the plurality of resource candidates includes the reserved resource.

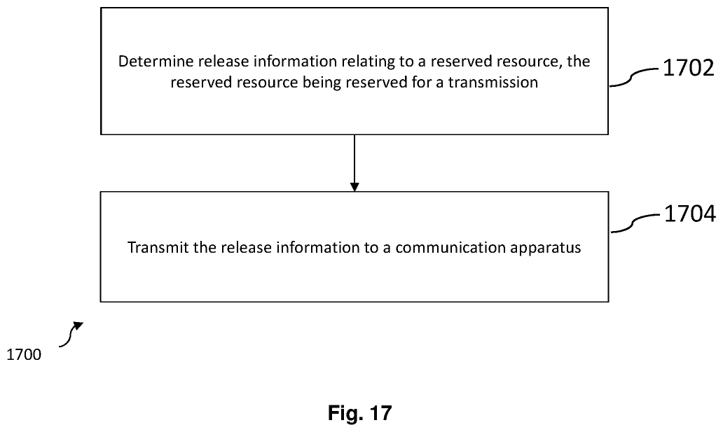

FIG. 17 shows a flow diagram 1700 illustrating a communication method according to various embodiments. In step 1702, release information relating to a reserved resource is determined, the reserved resource being reserved for a transmission. In step 1704, the release information is transmitted to a communication apparatus.

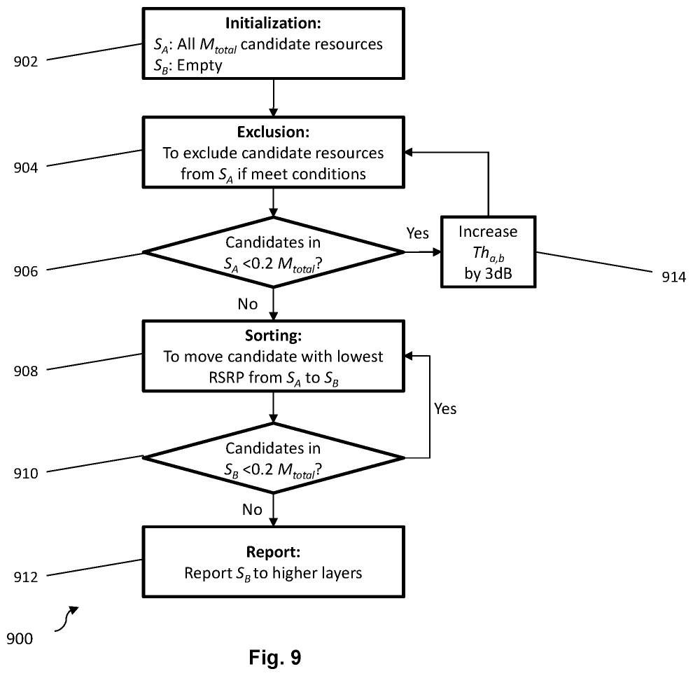

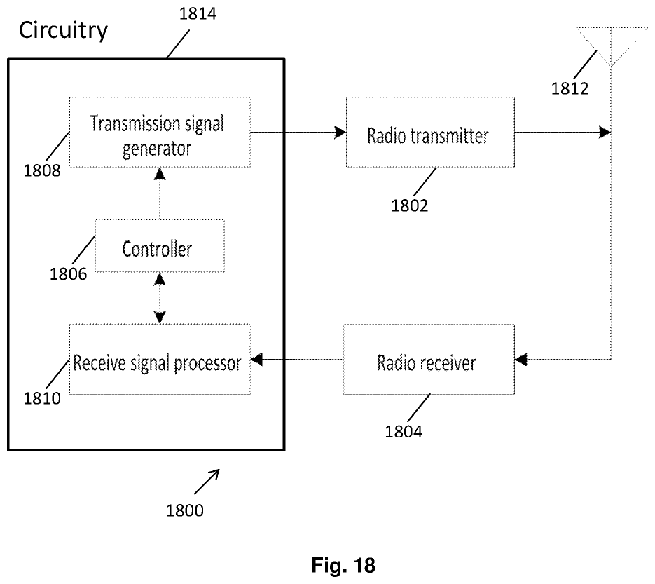

FIG. 18 shows a schematic, partially sectioned view of the communication apparatus 1800 that can be implemented for establishing the V2X communications in accordance with various embodiments as shown in FIGS. 1 to 17. The communication apparatus 1800 may be implemented as a UE or a base station according to various embodiments.

Various functions and operations of the communication apparatus 1300 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 18, the communication apparatus 1800 may include circuitry 1814, at least one radio transmitter 1802, at least one radio receiver 1804, and at least one antenna 1812 (for the sake of simplicity, only one antenna is depicted in FIG. 18 for illustration purposes). The circuitry 1814 may include at least one controller 1806 for use in software and hardware aided execution of tasks that the at least one controller 1806 is designed to perform, including control of communications with one or more other communication apparatuses in a wireless network. The circuitry 1814 may furthermore include at least one transmission signal generator 1808 and at least one receive signal processor 1810. The at least one controller 1806 may control the at least one transmission signal generator 1808 for generating signals (for example, a signal containing release information relating to a reserved resource) to be sent through the at least one radio transmitter 1802 to one or more other communication apparatuses and the at least one receive signal processor 1810 for processing signals (for example, a signal containing release information relating to a reserved resource) received through the at least one radio receiver 1804 from the one or more other communication apparatuses under the control of the at least one controller 1806. The at least one transmission signal generator 1308 and the at least one receive signal processor 1810 may be stand-alone modules of the communication apparatus 1800 that communicate with the at least one controller 1806 for the above-mentioned functions, as shown in FIG. 18. Alternatively, the at least one transmission signal generator 1808 and the at least one receive signal processor 1810 may be included in the at least one controller 1806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1802, at least one radio receiver 1804, and at least one antenna 1812 may be controlled by the at least one controller 1806.

The communication apparatus 1800, when in operation, provides functions required for utilization of a released resource. For example, the communication apparatus 1800 may be a UE, and the radio receiver 1804 may, in operation, receive release information relating to a reserved resource from another communication apparatus, the reserved resource being reserved for a transmission from the another communication apparatus. The circuitry 1814 may, in operation, select a resource from a plurality of resource candidates when the communication apparatus is to do a subsequent transmission, wherein the plurality of resource candidates includes the reserved resource.

The release information may be received over a PSFCH. The circuitry 18314 may be further configured to exclude or not exclude the reserved resource from the plurality of resource candidates, wherein judgement for excluding or not excluding the reserved resource from the plurality of resource candidates is done by a PHY layer or a MAC layer based on the release information. The selection of the resource may be done by a MAC layer.

The transmitter 1802 may, in operation, transmit the subsequent transmission using the selected resource. The transmitter 1802 may be further configured to transmit the release information to one or more other communication apparatus different from the another communication apparatus.

For example, the communication apparatus 1800 may be a UE, and the circuitry 1814 may, in operation, determine release information relating to a reserved resource, the reserved resource being reserved for a transmission from the communication apparatus. The transmitter 1802 may, in operation, transmit the release information to another communication apparatus.

The receiver 1804 may, in operation, receive the release information from a base station, an access point (AP) or a communication apparatus different from the another communication apparatus. The release information may be received over a PSFCH. The circuitry 1814 may be further configured to select a resource from a plurality of resource candidates when the communication apparatus is to do a subsequent transmission, wherein the plurality of resource candidates includes the reserved resource, and wherein the transmitter 1802 may be further configured to transmit the subsequent transmission using the selected resource.

The circuitry 1814 may be further configured to exclude or not exclude the reserved resource from the plurality of resource candidates, wherein judgement for excluding or not excluding the reserved resource from the plurality of resource candidates may be done by a PHY layer or a MAC layer based on the release information. The selection of the resource may be done by a MAC layer. The transmitter 1802 may be further configured to transmit the release information to a group of communication apparatuses.

As described above, the embodiments of the present disclosure provide an advanced communication system, communication methods and communication apparatuses for utilization of released resource that advantageously reduces chances of over-the-air collisions on the released resource.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
a receiver which, in operation, receives release information relating to a reserved resource from another communication apparatus, the reserved resource being reserved for a transmission from the another communication apparatus; and
circuitry which, in operation, selects a resource from a plurality of resource candidates when the communication apparatus is to do a subsequent transmission, wherein the plurality of resource candidates includes the reserved resource.

2. The communication apparatus according to claim 1, wherein the release information is received over a Physical Sidelink Feedback Channel (PSFCH).

3. The communication apparatus according to claim 1, wherein the circuitry is further configured to exclude or not exclude the reserved resource from the plurality of resource candidates, wherein judgement for excluding or not excluding the reserved resource from the plurality of resource candidates is done by a PHY layer or a MAC layer based on the release information.

4. The communication apparatus according to claim 1, wherein the selection of the resource is done by a MAC layer.

5. The communication apparatus according to claim 1, further comprising a transmitter, which, in operation, transmits the subsequent transmission using the selected resource.

6. The communication apparatus according to claim 5, wherein the transmitter is further configured to transmit the release information to one or more other communication apparatus different from the another communication apparatus.

7. A communication apparatus comprising:
circuitry which, in operation, determines release information relating to a reserved resource, the reserved resource being reserved for a transmission from the communication apparatus; and
a transmitter which, in operation, transmits the release information to another communication apparatus.

8. The communication apparatus according to claim 7, further comprising a receiver, which, in operation, receives the release information from a base station, an access point (AP) or a communication apparatus different from the another communication apparatus.

9. The communication apparatus according to claim 8, wherein the release information is received over a PSFCH.

10. The communication apparatus according to claim 7, wherein the circuitry is further configured to select a resource from a plurality of resource candidates when the communication apparatus is to do a subsequent transmission, wherein the plurality of resource candidates includes the reserved resource, and wherein the transmitter is further configured to transmit the subsequent transmission using the selected resource.

11. The communication apparatus according to claim 10, wherein the circuitry is further configured to exclude or not exclude the reserved resource from the plurality of resource candidates, wherein judgement for excluding or not excluding the reserved resource from the plurality of resource candidates is done by a PHY layer or a MAC layer based on the release information.

12. The communication apparatus according to claim 10, wherein the selection of the resource is done by a MAC layer.

13. The communication apparatus according to claim 7, wherein the transmitter is further configured to transmit the release information to a group of communication apparatuses.

14. A communication method comprising:
receiving release information relating to a reserved resource, the reserved resource being reserved for a transmission from a communication apparatus; and
selecting a resource from a plurality of resource candidates when a subsequent transmission is to be done, wherein the plurality of resource candidates includes the reserved resource.

15. A communication method comprising:
determining release information relating to a reserved resource, the reserved resource being reserved for a transmission; and
transmitting the release information to a communication apparatus.
